(19) United States
(12) Patent Application Publication
(10) Pub. No.: US 2017/0063708 A1
(43) Pub. Date: Mar. 2, 2017

(54) RESOURCE EXCHANGE SERVICE TRANSACTION FOR CLOUD COMPUTING

(71) Applicant: International Business Machines Corporation, Armonk, NY (US)

(72) Inventors: Jiun-Yang Hsu, New Taipei City (TW); Cheng-Ta Lee, Taipei City (TW); Dah Haur D. Lin, Taipei City (TW)

(21) Appl. No.: 14/841,979

(22) Filed: Sep. 1, 2015

(51) Int. Cl. H04L 12/911; H04L 12/24; H04L 29/08

(52) U.S. Cl. CPC H04L 47/70; H04L 67/1097; H04L 41/5003

(57) ABSTRACT

A method, a computer program product, and a computer system for exchanging cloud resources between tenants. A mediator system receives from a user a request for a cloud resource, aggregates the cloud resource from one or more of the tenants, and replies the request for a cloud resource with a description of the cloud resource. The mediator system receives from the user a request for resource delegation, initiates a transaction of the cloud resource, retrieves the cloud resource from a resource pool, and determines whether the cloud resource complies with an access control list (ACL) policy. The mediator system enforces a resource acquisition, in response to determining that the cloud resource complies with the ACL policy. The mediator system the request for resource delegation with a resource delegation result.

### TECHNICAL FIELD OF THE INVENTION

The present invention relates generally to cloud computing, and more particularly to optimizing cloud resource utilization.

### BACKGROUND

In the new cloud computing era, most of services will be hosted in the cloud. Enterprises rental or order of cloud resources from the public cloud provider will become imperative, in order to build their own services or construct their own private cloud. The definition of cloud resources has a wide range, ranging from hardware bare metal servers to software capability of the services. For example, the CPU processing power is one of the resources that can be rented or ordered from the cloud provider. Similarly, a database service can be another resource that can be rented or ordered from the cloud provider. Even though the utilization rate of resources is an important factor to ROI (return on investment), it is one of the major concerns in the cloud environment especially during peak hours. In order to deal with the burst requests during peak hours, every cloud tenant will need to base on their capacity planning to request sufficient resource to handle the situation. One ideal way the tenant can do is to request new resources on demand. But, in general, on-demand resources are much more expensive than persistent resources. In order to reduce the expense of ramping-up required resources during peak hours, the tenant can choose to request longer term persistent resources to save the cost. Presently, the anticipated cloud resource cost is depending on the pricing model from the service provider and the utilization rate accumulated for the resources during the entire rental period. As cloud environment becomes wide-spread across different industries, a more flexible way for tenants to request and consume the cloud resources will be a must in the future.

As of today, there is no mechanism for a cloud tenant to exchange resource with another tenant. If the resources in the cloud environment is exchangeable, one tenant can rent unused resource from another tenant and vice versa, the resource's total cost of ownership for each tenant will be reduced and overall cloud resources utilization will be improved. As a result, each tenant can always request longer term persistent resource in advance to have the best deal. At the same time, the offering resources can achieve ultimate utilization rate by exchanging resource with other tenants. The capability of facilitating cloud resource exchange among tenants opens a new business model and a new economical market in the IT world.

### SUMMARY

In one aspect, a method for exchanging cloud resources between tenants is provided. The method comprises receiving from a user, by a mediator system, a request for a cloud resource. The method further comprises aggregating, by the mediator system, the cloud resource from one or more of the tenants. The method further comprises replying, by the mediator system, the request for the cloud resource with a description of the cloud resource. The method further comprises receiving from the user, by the mediator system, a request for resource delegation. The method further comprises initiating, by the mediator system, a transaction of the cloud resource. The method further comprises retrieving, by the mediator system, the cloud resource from a resource pool. The method further comprises determining, by the mediator system, whether the cloud resource complies with an access control list (ACL) policy. The method further comprises enforcing, by the mediator system, a resource acquisition, in response to determining that the cloud resource complies with the ACL policy. The method further comprises replying, by the mediator system, the request for the resource delegation with a resource delegation result.

In another aspect, a computer program product for exchanging cloud resources between tenants is provided. The computer program product comprises a computer readable storage medium having program code embodied therewith. The program code is executable to: receive, by a mediator system, from a user, a request for a cloud resource; aggregate, by the mediator system, the cloud resource from one or more of the tenants; reply, by the mediator system, the request for the cloud resource with a description of the cloud resource; receive, by the mediator system, from the user, a request for resource delegation; initiate, by the mediator system, a transaction of the cloud resource; retrieve, by the mediator system, the cloud resource from a resource pool; retrieve, by the mediator system, the cloud resource from a resource pool; enforce, by the mediator system, a resource acquisition, in response to determining that the cloud resource complies with the ACL policy; and reply, by the mediator system, the request for the resource delegation with a resource delegation result.

In yet another aspect, a computer system for exchanging cloud resources between tenants is provided. The computer system comprises one or more processors, one or more computer readable tangible storage devices, and program instructions stored on at least one of the one or more computer readable tangible storage devices for execution by at least one of the one or more processors. The program instructions are executable to receive, by a mediator system, from a user, a request for a cloud resource. The program instructions are executable to aggregate, by the mediator system, the cloud resource from one or more of the tenants. The program instructions are executable to reply, by the mediator system, the request for the cloud resource with a description of the cloud resource. The program instructions are executable to receive, by the mediator system, from the user, a request for resource delegation. The program instructions are executable to initiate, by the mediator system, a transaction of the cloud resource. The program instructions are executable to retrieve, by the mediator system, the cloud resource from a resource pool. The program instructions are executable to determine, by the mediator system, whether the cloud resource complies with an access control list (ACL) policy. The program instructions are executable to enforce, by the mediator system, a resource acquisition, in response to determining that the cloud resource complies with the ACL policy. The program instructions are executable to reply, by the mediator system, the request for the resource delegation with a resource delegation result.

### BRIEF DESCRIPTION OF THE SEVERAL VIEWS OF THE DRAWINGS

FIG. 1 is a diagram showing a mediator system for exchanging cloud resources between tenants, in accordance with one embodiment of the present invention.

FIG. 2 shows the BSS (Business Support System) logic supported by a transaction management system in a mediator system shown in FIG. 1, in accordance with one embodiment of the present invention.

FIG. 3 is a systematic diagram showing a resource query flow, in accordance with one embodiment of the present invention.

FIG. 4 is a flow chart showing operational steps of a resource query flow, in accordance with one embodiment of the present invention.

FIG. 5 is a systematic diagram showing resource advertisements by tenants, in accordance with one embodiment of the present invention.

FIG. 6 is a flow chart showing operational steps of resource advertisements by tenants, in accordance with one embodiment of the present invention.

FIG. 7 is a systematic diagram showing resource exchange between tenants via a mediator, in accordance with one embodiment of the present invention.

FIG. 8 is a systematic diagram showing resource delegation, in accordance with one embodiment of the present invention.

FIG. 9 is a flow chart showing operational steps of resource delegation, in accordance with one embodiment of the present invention.

FIG. 10 is a systematic diagram showing modification of resource ownerships by a SLA (service level agreement) module and cloud controllers, in accordance with one embodiment of the present invention.

FIG. 11 is a flow chart showing operational steps of modification of resource ownerships by a SLA module and cloud controllers, in accordance with one embodiment of the present invention.

FIG. 12 is a systematic diagram showing transactions between two mediator systems, in accordance with one embodiment of the present invention.

FIG. 13 is a diagram illustrating a computer device hosting a mediator system, in accordance with one embodiment of the present invention.

### DETAILED DESCRIPTION

In embodiments of the present invention, a system for optimizing the cloud resource utilization rate is disclosed. The solution provides a mechanism that helps cloud tenants to exchange cloud resources among them. There are four workloads in the system.

The first workload of the system is to aggregate resource advertisements from tenants, users, or mediators. When tenants advertise their resources for renting or exchanging, tenants need to clearly specify the resource types and the terms of use. The resource types can be computing power, storage, memory, database services, web servers, and etc. Embodiments of the present invention do not attempt to cover all the details of possible resource types in the cloud environment. The terms of use of the resource specified how the resource can be used, how the resources can be charged, and how the resource can be returned to the owner. For example, the charge items can be CPU cycle, disk usage, IO rate, network bandwidth, and etc. Moreover, an owner of the resources can specify the duration of resource rental and the time to return to the owner. Also, embodiments of the present invention will not attempt to cover the details of the terms of use for resources either. Tenants can advertise their resources in a common platform that others can have access to, for example an eBay™ for cloud resources. Essentially, this common platform is established at a market place for the cloud resources.

The second workload of the system is to regulate resource sharing between tenants, users, and/or mediators. In the process of renting cloud resources from each other, a tenant needs to have a trustworthy third-party entity (may be a public consortium) to host the transaction of the resources and manage the SLA (service level agreement) contract between a renter and a loaner of the cloud resources. For example, when one tenant rents its database service to another tenant for 3 months, it is important to guarantee that the owner will not break the contract and take back the database service. At the same time, the renter needs to ensure that the rent is fulfilled at the end of the contract period. The trustworthy third-party entity can reside in the same cloud or in other places. Since this third-party entity is granted a full control to resources advertised by tenants, it would also responsible for maintaining and managing all resources in a specific environment (e.g., a cloud).

The third workload is resource exchange transactions between tenants, users, and or mediators. The mediator record all the interactions between tenants, users, and/or mediators for the auditing and billing purpose. The mediator system initiates a new transaction for exchanging resources between two tenants, users, and/or mediators.

The fourth workload is resource consolidation among cloud resources collected from tenants, users, and or mediators. In such resource exchangeable environment, the mechanism to allow a renting tenant to deploy workload onto the rented resources is outside of scope of this invention. And, therefore, this invention will not attempt to cover the details of workload deployment in the cloud.

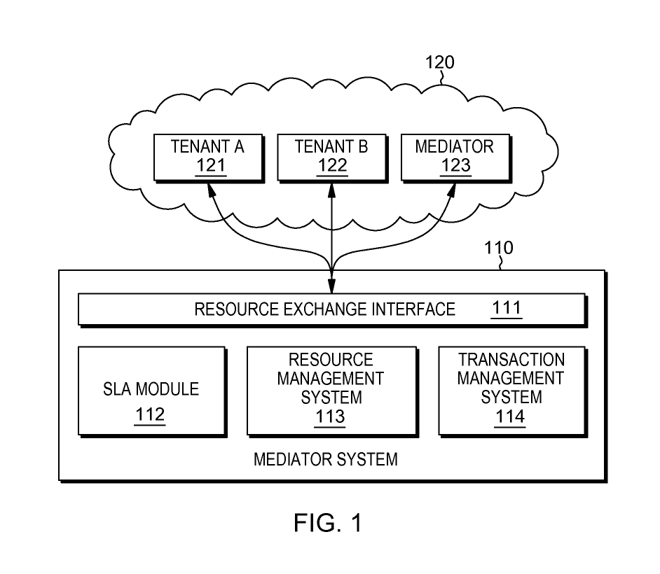

FIG. 1 is a diagram showing mediator system 110 for exchanging cloud resources between tenants, in accordance with one embodiment of the present invention. Shown in FIG. 1, cloud 120 includes tenant A 121, tenant B 122, and mediator 123. Mediator system 110 includes resource exchange interface 111, SLA module 112, resource management system 113, and transaction management system 114.

A resource advertisement and a resource inquiry request are sent to mediator system 110 via resource exchange interface 111. Resource exchange interface 111 can be a RESTful web interface or using any other implementations. Tenant A 121 and tenant B 122 can access resource exchange interface 111 to query the resource inventory, transaction history, biding status, SLA, resource usage, and etc. Tenant A 121 and tenant B 122 can also use resource exchange interface 111 to submit order requests and resource advertisement messages.

Referring to FIG. 1, SLA module 112 keeps track of the resource usage in tenant A 121 and tenant B 122. It needs to make sure the resource ordered by a tenant is always available to enact its SLA. When a tenant breaks its SLA from one side (e.g. the tenant suddenly takes back the resource it has rented to another tenant). If SLA module 112 corporates with the cloud provider, it can somehow enforce the tenant to follow the SLA. However, if such connection between SLA and the cloud provider doesn't exist, SLA module 112 may need to prepare the backup resource as the replacement to enact the SLA.

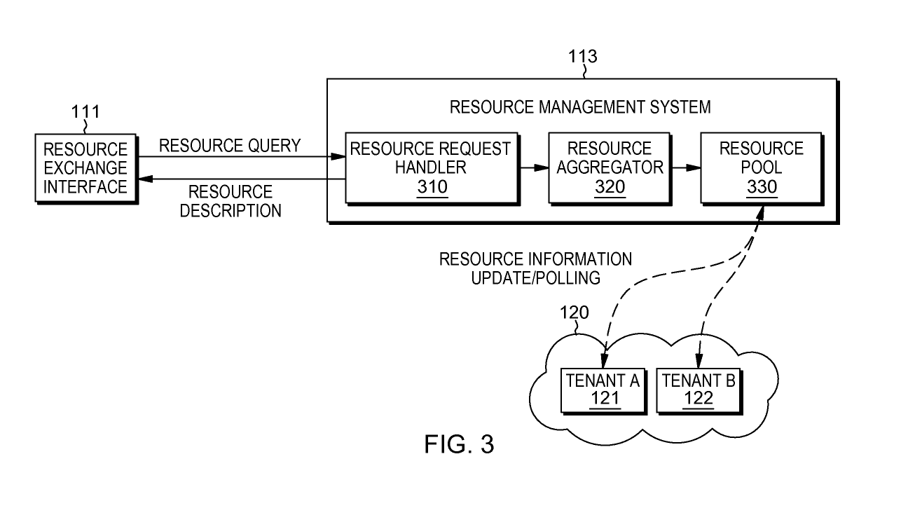

When a resource ordering request is received by mediator system 110, it may not be able to fulfill the request by using the resource rented by only one tenant. It may need to aggregate the resources from multiple tenants in order to fulfill the order. Resource management system 113 can also optimize the resource utilization in a resource pool (which is shown in FIG. 3). For example, it can base on the geography information to determine which resource is suitable to the tenant sent the order.

When a tenant (tenant A 121 or tenant B 122) advertises its unused and ready-to-rent resources to mediator system 110, mediator system 110 will record all the necessary information in its resource pool (which is shown in FIG. 3). Mediator 123 may either collect all the advertised resources in advance or wait until actual order requests are made. The resources stored in the resource pool can be in many forms, for example, meditator system 110 can get the access right to the tenant's resources through SAML or OAuth in order to collect the resources on the fly. SAML (Security Assertion Markup Language) is an XML-based, open-standard data format for exchanging authentication and authorization data between parties, in particular, between an identity provider and a service provider. OAuth is an open standard for authorization and provides client applications a secure delegated access to server resources on behalf of a resource owner. In this case, the representation of the resources is just a tenant's credential followed by an access control policy. The other possible representation of the resources may be the actual resources migrated from a tenant (tenant A 121 or tenant B 122) to mediator system 110. For example, if a tenant (tenant A 121 or tenant B 122) advertises a group of virtual machines to mediator system 110, mediator system 110 may just migrate the VM group from this tenant. A cloud provider may also open a special interface for mediator system 110.

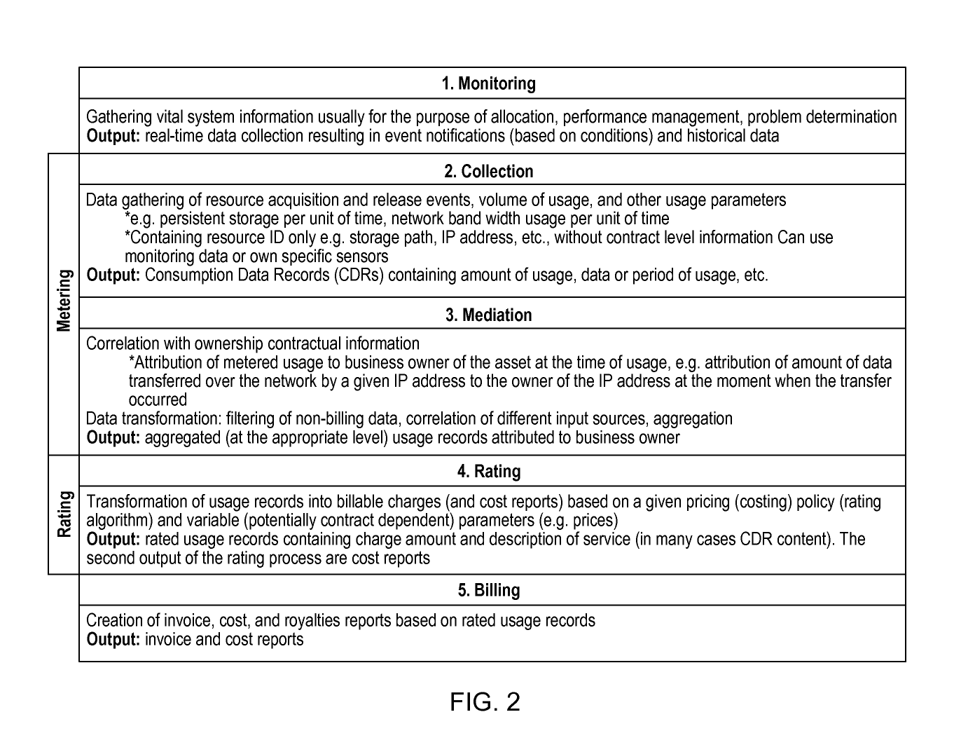

Once resource management system 113 collects all the resources to fulfill the request order, the actual resource delivery must pass transaction management system 114 to avoid race conditions. It is possible that two requests use overlapped resources, transaction management system 114 is the last enforcement point to make sure it will not happen. Transaction management system 114 maintains all the trading and rental records on mediator system 110. It may also manage the bidding system and maintain the bidding history. Transaction management system 114 also handles the BBS (Business Support System) logic shown in FIG. 2.

FIG. 2 shows the BSS (Business Support System) logic supported by transaction management system 114 in mediator system 110 shown in FIG. 1, in accordance with one embodiment of the present invention.

The BSS logic includes monitoring. In monitoring, transaction management system 114 gathers vital system information usually for the purpose of allocation, performance management, and problem determination. The real-time data collection results in event notifications (based on conditions) and historical data. The BSS logic further includes collection. In the collection, transaction management system 114 gathers data of resource acquisition and release events, the volume of usage, and other usage parameters. For example, the data includes persistent storage usage per unit of time and network bandwidth usage per unit of time. The data may include resource ID only without contract level information, for example, storage path, ID address, and etc. The output of the collection is consumption data records, which include amounts of usage, date or period of usages, and etc. The BSS logic further includes mediation. Through the mediation, transaction management system 114 aggregates usage records attributed to the business owner. The BSS logic further includes rating. In the rating, transaction management system 114 transforms usage records into billable charges (and cost reports) based on a given pricing policy (or rating algorithm) and variable parameters (e.g., prices). The BSS logic further includes billing. Transaction management system 114 creates invoice, cost, and royalty reports based on rated usage reports.

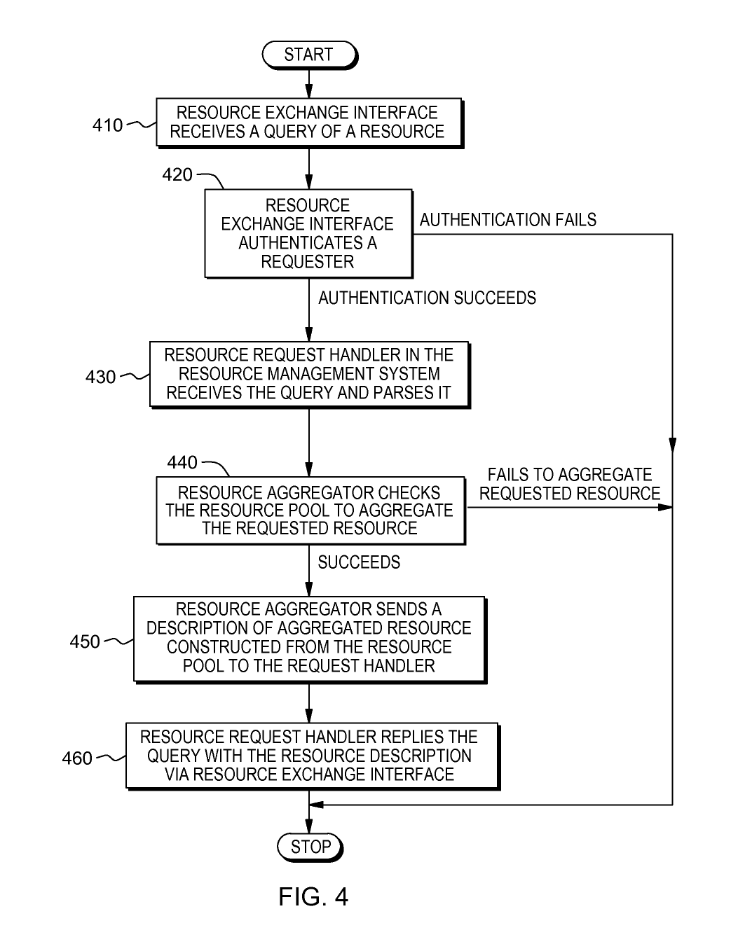

FIG. 3 is a systematic diagram showing a resource query flow, in accordance with one embodiment of the present invention. FIG. 4 is a flow chart showing operational steps of a resource query flow shown in FIG. 3, in accordance with one embodiment of the present invention. The operational steps of a resource query flow are discussed in detailed with reference to FIG. 3 and FIG. 4. At step 410, resource exchange interface 111 (shown in FIG. 3 as well as FIG. 1) receives from a user a query of a resource. At step 420, resource exchange interface 111 authenticates the requester. In response to determining that the authentication fails, resource exchange interface 111 terminates the operation. In response to determining that the authentication succeeds, at step 430, resource request handler 310 (shown in FIG. 3) in resource management system 113 (shown in FIG. 3 as well as FIG. 1) receives the query and parses it. At step 440, resource aggregator 320 (shown in FIG. 3) in resource management system 113 checks resource pool 330 (shown in FIG. 3) in resource management system 113 to aggregate the requested resource. In response to failing to aggregate the requested source, resource management system 113 terminates the operation. At step 450, resource aggregator 320 sends, to resource request handler 310, a description of aggregated resource which is constructed from resource pool 330. At step 460, resource request handler 310 replies the query with the description of the aggregated resource via resource exchange interface 111.

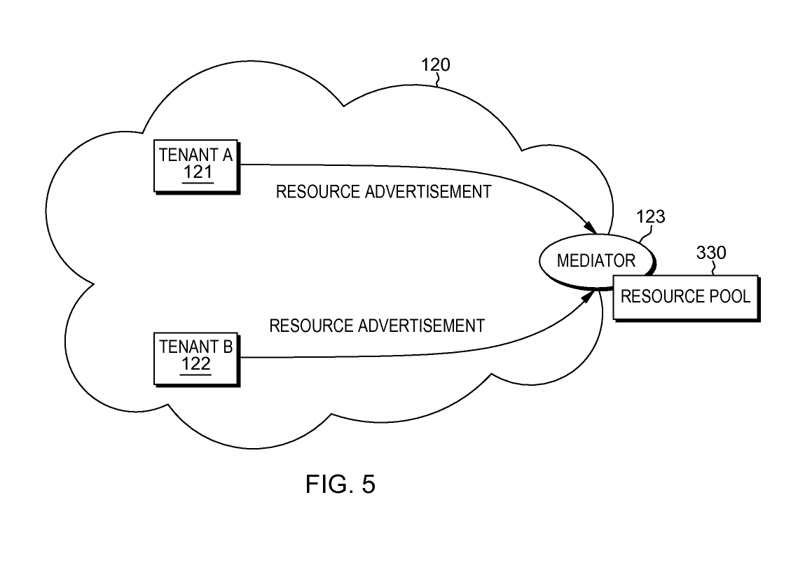

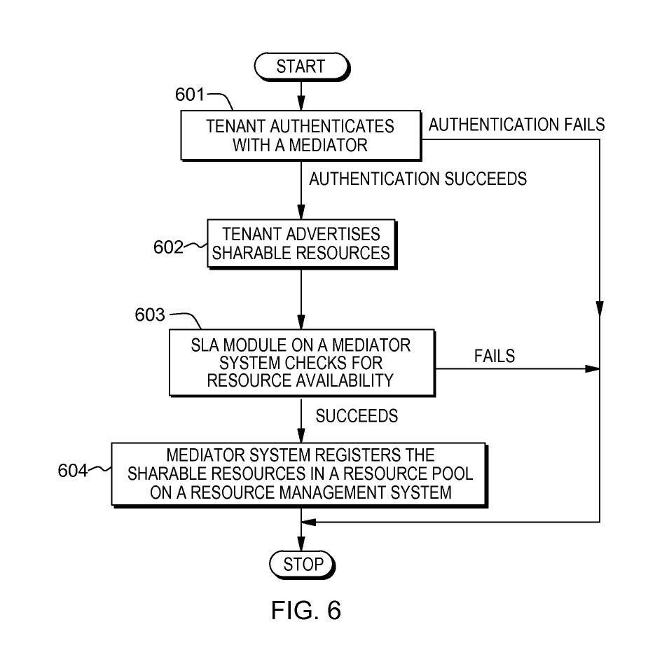

FIG. 5 is a systematic diagram showing resource advertisements by tenant A 121 and tenant B 122, in accordance with one embodiment of the present invention. FIG. 6 is a flow chart showing operational steps of resource advertisements by tenant A 121 and tenant B 122, in accordance with one embodiment of the present invention. The operational steps of resource advertisements are discussed in detailed with reference to FIG. 5 and FIG. 6. At step 601, tenant A 121 or tenant B 122 in cloud 120 authenticates with mediator 123 in cloud 120. In response to determining that the authentication fails, the operation of the resource advertisements will be terminated. In response to determining that the authentication succeeds, at step 602, tenant A 121 or tenant B 122 advertises sharable resources. Shown as in FIG. 5, tenant A 121 or tenant B 122 advertises the sharable resource via mediator 123. At step 603, SLA module 112 (shown in FIG. 1) on mediator system 110 checks for resource availability. In response to determining that the resources availability fails, the operation is terminated. In response to determining that the resources availability succeeds, at step 604, mediator system 110 registers the sharable resources in resource pool 330 on resource management system 113.

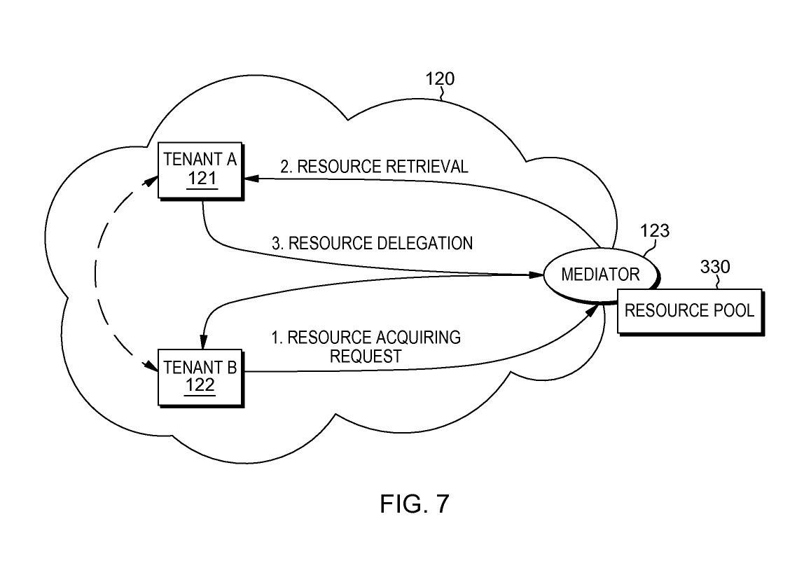

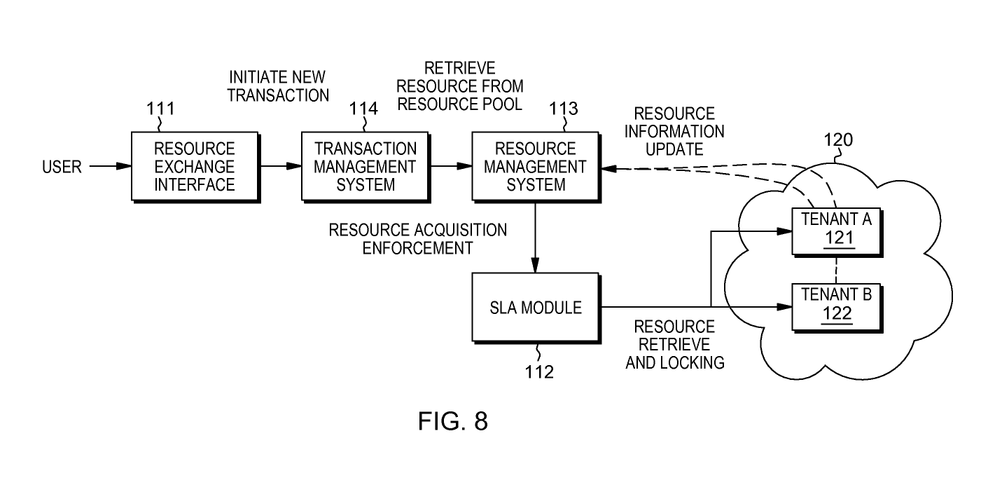

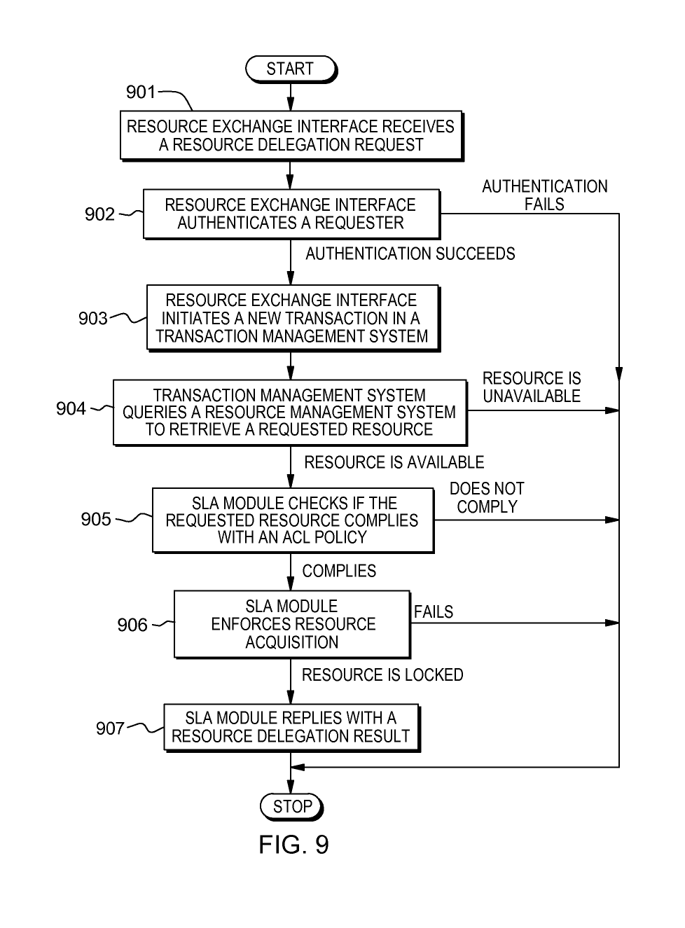

FIG. 7 is a systematic diagram showing resource exchange between tenant A 121 and tenant B 122 via mediator 123, in accordance with one embodiment of the present invention. FIG. 7 shows an example of resource exchange between tenants via a mediator. As shown in FIG. 7, the resource exchange between tenant A 121 and tenant B 122 via mediator 123 follows the steps: tenant B 122 sends to mediator 123 a request for resource acquiring, mediator 123 sends to tenant B 122 a request for resource retrieval, and tenant B 122 finishes resource delegation. The resource delegation is described with reference to FIG. 8 and FIG. 9.

FIG. 8 is a systematic diagram showing resource delegation, in accordance with one embodiment of the present invention. FIG. 9 is a flow chart showing operational steps of resource delegation, in accordance with one embodiment of the present invention. At step 901, resource exchange interface 111 receives from a user a request for resource delegation. At step 902, resource exchange interface 111 authenticates a requester or the user. In response to determining that the authentication fails, resource exchange interface 111 terminates the operation. In response to determining that the authentication succeeds, at step 903, resource exchange interface 111 initiates a new transaction in transaction management system 114. At step 904, transaction management system 114 queries resource management system 113 to retrieve a requested resource. In response to determining that the requested resource is unavailable, transaction management system 114 terminates the operation. In response to determining that the requested resource is available, at step 905, SLA module 112 checks whether the requested resource complies with an access control list (ACL) policy. In response to determining that requested resource does not comply with the ACL policy, the operation of the resource delegation is terminated. In response to determining that requested resource complies with the ACL policy, at step 906, SLA module 112 enforces resource acquisition. Then, the requested resource is locked. At step 907, SLA module 112 replies with a resource delegation result.

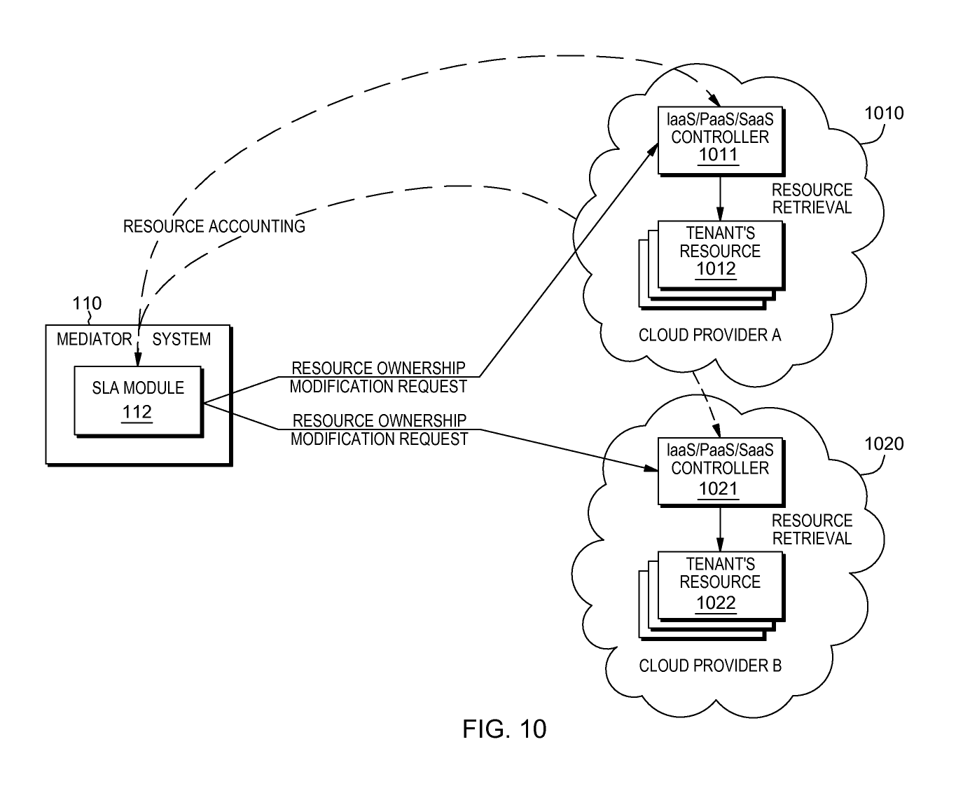

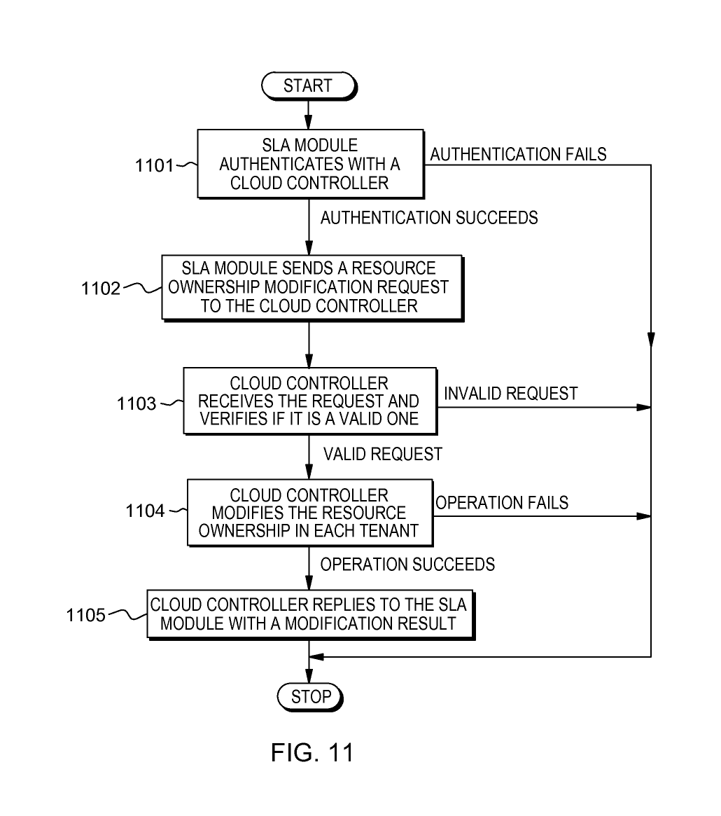

FIG. 10 is a systematic diagram showing modification of resource ownerships by SLA module 112 and IaaS/PaaS/SaaS controllers 1011 and 1021, in accordance with one embodiment of the present invention. FIG. 11 is a flow chart showing operational steps of modification of resource ownerships by SLA module 112 and controllers 1011 and 1021, in accordance with one embodiment of the present invention. Controller 1011 manages tenant's resource 1012 in cloud provider A 1010, and controller 1021 manages tenant's resource 1022 in cloud provider B 1020. The operational steps of the modification of resource ownerships are discussed in detailed with reference to FIG. 10 and FIG. 11. At step 1101, SLA module 112 authenticates with a cloud controller (controller 1011 or 1021). In response to determining that the authentication fails, SLA module 112 terminates the operation of the modification of resource ownerships. In response to determining that the authentication succeeds, at step 1102, SLA module 112 sends to controller 1011 or 1021 a request for modifying resource ownerships. At step 1103, controller 1011 or 1021 receives the request and verifies whether it is a valid one. In response to determining that the request is invalid, the operation of the modification of resource ownerships is terminated. In response to determining that the request is valid, at step 1104, controller 1011 or 1021 modifies the resource ownerships in each tenant. In response to determining that the operation of the modification of resource ownerships fails, the operation is terminated. In response to determining that the operation of the modification of resource ownerships succeeds, controller 1011 or 1021 at step 1105 replies SLA module 112 with a modification result.

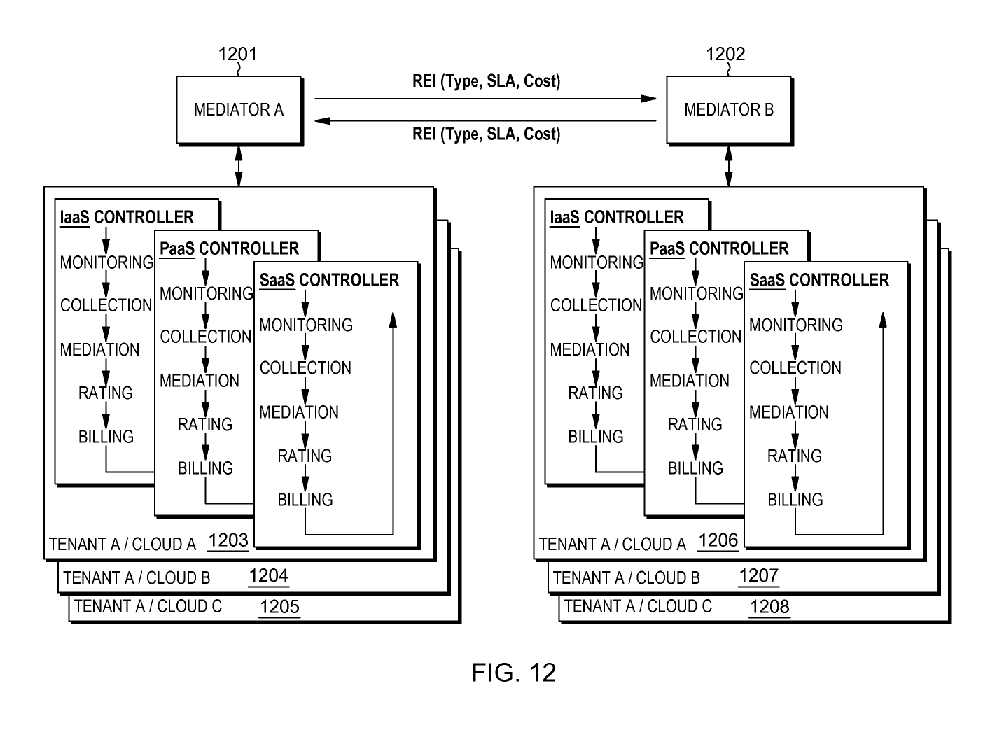

FIG. 12 is a systematic diagram showing transactions between two mediator systems (mediator A 1201 and mediator B 1202), in accordance with one embodiment of the present invention. As shown in FIG. 12, there are two mediators: mediator A 1201 and mediator B 1202. Mediator A 1201 works with controller 1203 for tenant A in cloud A, controller 1204 for tenant A in cloud B, and controller 1205 for tenant A in cloud C. Mediator B 1202 works with controller 1206 for tenant A in cloud A, controller 1207 for tenant A in cloud B, and controller 1208 for tenant A in cloud C. As shown in FIG. 12, mediator A 1201 sends a resource request to Mediator B 1202. The request contains a resource type and SLA. Mediator B 1202 then replies with a cost of the requested resource.

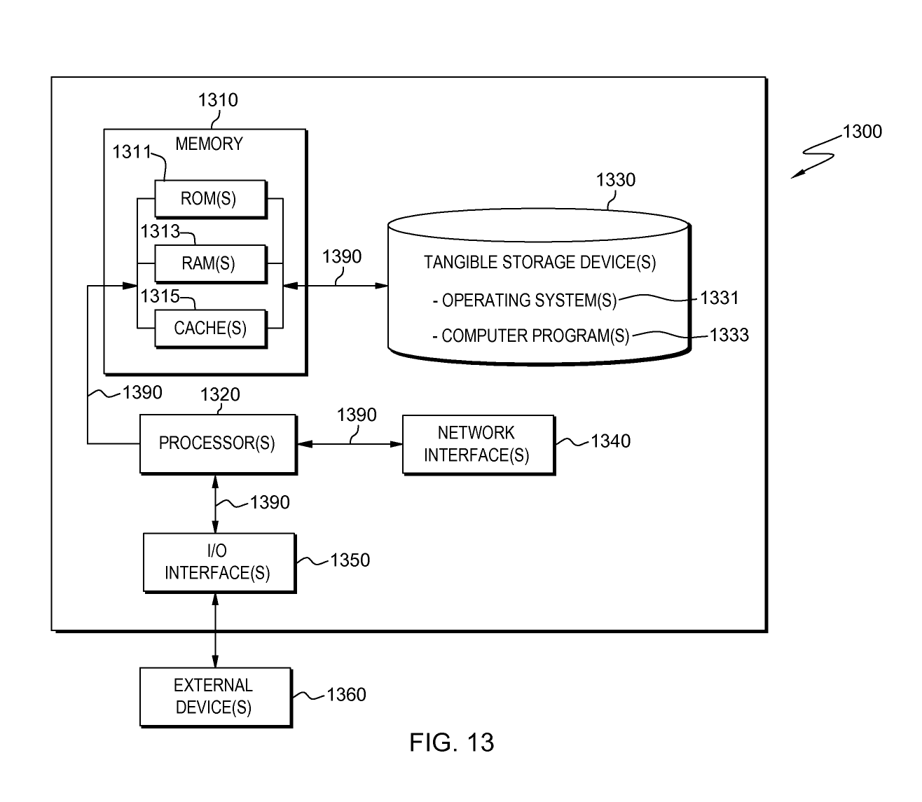

FIG. 13 is a diagram illustrating components of computer device 1300 hosting mediator system 110, in accordance with one embodiment of the present invention. It should be appreciated that FIG. 13 provides only an illustration of one implementation and does not imply any limitations with regard to the environment in which different embodiments may be implemented.

Referring to FIG. 13, computer device 1300 includes processor(s) 1320, memory 1310, and tangible storage device(s) 1330. In FIG. 13, communications among the above-mentioned components of computer device 1300 are denoted by numeral 1390. Memory 1310 includes ROM(s) (Read Only Memory) 1311, RAM(s) (Random Access Memory) 1313, and cache(s) 1315. One or more operating systems 1331 and one or more computer programs 1333 reside on one or more computer readable tangible storage device(s) 1330. Computer device 1300 further includes I/O interface(s) 1350. I/O interface(s) 1350 allows for input and output of data with external device(s) 1360 that may be connected to computer device 1300. Computer device 1300 further includes network interface(s) 1340 for communications between computer device 1300 and a computer network.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device, such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network (LAN), a wide area network (WAN), and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++, and conventional procedural programming languages, such as the “C” programming language, or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture, including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the FIGs illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the FIGs. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for exchanging cloud resources between tenants, the method comprising:
receiving, by a mediator system, from a user, a request for a cloud resource;
aggregating, by the mediator system, the cloud resource from one or more of the tenants;
replying, by the mediator system, the request for the cloud resource with a description of the cloud resource;
receiving, by the mediator system, from the user, a request for resource delegation;
initiating, by the mediator system, a transaction of the cloud resource;
retrieving, by the mediator system, the cloud resource from a resource pool;
determining, by the mediator system, whether the cloud resource complies with an access control list policy;
enforcing, by the mediator system, a resource acquisition, in response to determining that the cloud resource complies with the access control list policy; and
replying, by the mediator system, the request for the resource delegation with a resource delegation result.

2. The method of claim 1, further comprising:
receiving, by the mediator system, from the tenants, advertisements of the cloud resources;
checking, by the mediator system, availability of the cloud resources; and
registering, by the mediator system, the cloud resources in the resource pool.

3. The method of claim 1, further comprising:
receiving, by a cloud controller, from the mediator system, a request for modifying an ownership of the cloud resource;
modifying, by the cloud controller, the ownership of the cloud resource; and
replying, by the cloud controller, the mediator system with a modification result.

4. The method of claim 1, wherein the mediator system comprises a resource exchange interface configured to receive advertisements of the cloud resources, to receive the request for the cloud resource and the request for the resource delegation, and to initiate the transaction of the cloud resource; wherein the mediator system comprises a service level agreement (SLA) module configured to track resource usage, to check availability of the cloud resource, and to enforce the resource acquisition; wherein the mediator system comprises a transaction management system configured to manage the transaction of the cloud resource and to maintain a record of the transaction.

5. The method of claim 4, wherein the mediator system further comprises an resource management system; wherein the resource management system comprises a resource request handler configured to receive the request for the cloud resource, to parse the request, and to reply the request via the resource exchange interface; wherein the resource management system comprises a resource aggregator configured to aggregate the cloud resource from the one or more of the tenants; wherein the resource pool is in the resource management system.

6. The method of claim 1, further comprising:
sending, by the mediator system, to a second mediator system, the request for the cloud resource; and
receiving, by the mediator system, from the second mediator system, a reply to the request for the cloud resource.

7. A computer program product for exchanging cloud resources between tenants, the computer program product comprising a computer readable storage medium having program code embodied therewith, the program code executable to:
receive, by a mediator system, from a user, a request for a cloud resource;
aggregate, by the mediator system, the cloud resource from one or more of the tenants;
reply, by the mediator system, the request for the cloud resource with a description of the cloud resource;
receive, by the mediator system, from the user, a request for resource delegation;
initiate, by the mediator system, a transaction of the cloud resource;
retrieve, by the mediator system, the cloud resource from a resource pool;
determine, by the mediator system, whether the cloud resource complies with an access control list policy;
enforce, by the mediator system, a resource acquisition, in response to determining that the cloud resource complies with the access control list policy; and
reply, by the mediator system, the request for the resource delegation with a resource delegation result.

8. The computer program product of claim 7, further comprising the program code executable to:
receive, by the mediator system, from the tenants, advertisements of the cloud resources;
check, by the mediator system, availability of the cloud resources; and
register, by the mediator system, the cloud resources in the resource pool.

9. The computer program product of claim 7, further comprising the program code executable to:
receive, by a cloud controller, from the mediator system, a request for modifying an ownership of the cloud resource;
modify, by the cloud controller, the ownership of the cloud resource; and
reply, by the cloud controller, the mediator system with a modification result.

10. The computer program product of claim 7, wherein the mediator system comprises a resource exchange interface configured to receive advertisements of the cloud resources, to receive the request for the cloud resource and the request for the resource delegation, and to initiate the transaction of the cloud resource; wherein the mediator system comprises a service level agreement (SLA) module configured to track resource usage, to check availability of the cloud resource, and to enforce the resource acquisition; wherein the mediator system comprises a transaction management system configured to manage the transaction of the cloud resource and to maintain a record of the transaction.

11. The computer program product of claim 10, wherein the mediator system further comprises an resource management system; wherein the resource management system comprises a resource request handler configured to receive the request for the cloud resource, to parse the request, and to reply the request via the resource exchange interface; wherein the resource management system comprises a resource aggregator configured to aggregate the cloud resource from the one or more of the tenants; wherein the resource pool is in the resource management system.

12. The computer program product of claim 7, further comprising the program code executable to:
send, by the mediator system, to a second mediator system, the request for the cloud resource; and
receive, by the mediator system, from the second mediator system, a reply to the request for the cloud resource.

13. A computer system for exchanging cloud resources between tenants, the computer system comprising:
one or more processors, one or more computer readable tangible storage devices, and program instructions stored on at least one of the one or more computer readable tangible storage devices for execution by at least one of the one or more processors, the program instructions executable to:
receive, by a mediator system, from a user, a request for a cloud resource;
aggregate, by the mediator system, the cloud resource from one or more of the tenants;
reply, by the mediator system, the request for the cloud resource with a description of the cloud resource;
receive, by the mediator system, from the user, a request for resource delegation;
initiate, by the mediator system, a transaction of the cloud resource;
retrieve, by the mediator system, the cloud resource from a resource pool;
determine, by the mediator system, whether the cloud resource complies with an access control list policy;
enforce, by the mediator system, a resource acquisition, in response to determining that the cloud resource complies with the access control list policy; and
reply, by the mediator system, the request for the resource delegation with a resource delegation result.

14. The computer system of claim 13, further comprising the program instructions executable to:
receive, by the mediator system, from the tenants, advertisements of the cloud resources;
check, by the mediator system, availability of the cloud resources; and
register, by the mediator system, the cloud resources in the resource pool.

15. The computer system of claim 13, further comprising the program instructions executable to:
receive, by a cloud controller, from the mediator system, a request for modifying an ownership of the cloud resource;
modify, by the cloud controller, the ownership of the cloud resource; and
reply, by the cloud controller, the mediator system with a modification result.

16. The computer system of claim 13, wherein the mediator system comprises a resource exchange interface configured to receive advertisements of the cloud resources, to receive the request for the cloud resource and the request for the resource delegation, and to initiate the transaction of the cloud resource; wherein the mediator system comprises a service level agreement (SLA) module configured to track resource usage, to check availability of the cloud resource, and to enforce the resource acquisition; wherein the mediator system comprises a transaction management system configured to manage the transaction of the cloud resource and to maintain a record of the transaction.

17. The computer system of claim 16, wherein the mediator system further comprises an resource management system; wherein the resource management system comprises a resource request handler configured to receive the request for the cloud resource, to parse the request, and to reply the request via the resource exchange interface; wherein the resource management system comprises a resource aggregator configured to aggregate the cloud resource from the one or more of the tenants; wherein the resource pool is in the resource management system.

18. The computer system of claim 13, further comprising the program instructions executable to:
send, by the mediator system, to a second mediator system, the request for the cloud resource; and
receive, by the mediator system, from the second mediator system, a reply to the request for the cloud resource.
